(19) United States
(12) Patent Application Publication
(10) Pub. No.: US 2024/0103507 A1
(43) Pub. Date: Mar. 28, 2024

(54) A DIAGNOSTIC ARRANGEMENT

(71) Applicant: KEMIRA OYJ, Helsinki (FI)

(72) Inventors: Torsten HAVERINEN-NIELSEN, Espoo (FI); Marjatta PIIRONEN, Espoo (FI); Iiris JOENSUU, Espoo (FI); Vesa-Matti TIKKALA, Espoo (FI)

(21) Appl. No.: 17/769,053

(22) PCT Filed: Oct. 13, 2020
(86) PCT No.: PCT/FI2020/050676

§ 371 Date: Apr. 14, 2022

(30) Foreign Application Priority Data
Oct. 16, 2019 (FI) 20195892

(51) Int. Cl. G05B 23/02

(52) U.S. Cl. CPC G05B 23/024

(57) ABSTRACT

The invention provides a diagnostic arrangement, which utilizes pre-processed measurement data, ML values and explanation values. By using all these values/data it is possible to analyse phenomenon, events, and behaviour of the process in such a way that a number of aspects can be taken into account.

### FIELD OF TECHNOLOGY

The invention relates to diagnostic of a process and its control. The process is, for example, a water treatment device, a paper machine etc.

### PRIOR ART

Nowadays machine learning algorithms are used with systems, which analyze and estimate behavior of a process like a paper machine or a water treatment. Processes are usually multivariable processes so they can be very difficult to follow or understand. Machine learning provides systems the ability to automatically learn and also to improve from experience without being explicitly programmed. So, machine learning (ML) utilities algorithms and statistical models that computer systems use to perform a specific task or tasks without using explicit instructions. There exist several ML algorithms. Here only some of them are mentioned: linear regression, logistic regression, K-means, feed-forward neural networks etc.

The reasoning for the outcomes of the ML algorithms are usually difficult to interpret, especially from complex processes. Therefore, explanation values are used to help user to interpret the outcomes. So, the explanations values are used for explaining how a ML algorithm has come to a specific result and also for classifying how a process works. The explanation values are obtained by using, for example, SHAP (Shapley additive explanations) values, LIME method or DeepLIFT method.

FIG. 1 shows an example of a known control arrangement, where a process 1 is driven by an actuator 2, which is controlled by a controller 3. Measurements 4 are taken from the process and they are used as feedback data for controller. The controller compares the measurements with a setpoint value or values 5 and forms a control command/s for the actuator.

The measurement 4 can also be used for other purposes in which case it is convenient that the measurement data are pre-processed 6 before it is actually used. The pre-processing may, for example, comprise data merging, aligning time format, modifying metadata, data validation etc. In the example of FIG. 1 machine learning (ML) 7 is used for extracting information and patterns in large datasets. The matching learning algorithms are usually based on statistical models, which a computer can use to perform a certain task without having exact instructions but relies instead on recognizing patterns. The recognized patterns can be obtained by building a mathematical model based on a training dataset. Predictions (simulations) and pattern recognition can be made by feeding new data to the mathematical model.

Because it is hard to see what is going on in the process from the output (predictions/simulations) of ML, the explanation values 8, SHAP values in the embodiment of FIG. 1, are used to track how ML predictions link back to the input variables. For each prediction a rating number is calculated for each input variable indicating how the variable is contributing to the final predictions. These rating numbers can be seen as explanation values indicating the significance of an input value at a given point in time.

The explanation values are uses to validate how the ML algorithms and the ML models work 9. This can be done more easily from the explanation values than from the ML predictions. So, the ML models can be changed if they do not work properly.

The ML values are used in a predicting unit 10 to predict the behavior of the process. The predictions can be used to provide recommendations 12, to the process 1. The predictions may also be used to suggest corrections 11 to change a setpoint/s 5 of the controller/s 3.

Although, the ML values are used, there is not an arrangement, that could utilize other data as well, and in an automatic way.

### Short Description

The object of the invention is to provide a diagnostic arrangement, which utilizes pre-processed measurement data, ML values and explanation values. By using all these values/data it is possible to analyse phenomenon, events, and behaviour of the process in such a way that a number of aspects can be taken into account. This can be done automatically. The object is achieved in a way described in the independent claim. Dependent claims illustrate different embodiments of the invention.

An inventive diagnostic arrangement for a multivariable process comprises a data processing module 6 in order to process measurement data of the multivariable process and to perform pre-processed measurement data 6A. The arrangement further comprises a machine learning module 7 in order to perform machine learning values 7A from the pre-processed measurement data 6A. The diagnostic arrangement comprises also an explanation value module 8 for forming explanation values 8A from the machine learning values 7A, and a deviation calculation module 14. The deviation calculation module is arranged to calculate deviations 8D between the explanation values 8A and normal explanation values 8N, deviations 7D between the machine learning values 7A and normal machine learning values 7N, and deviations 6D between the pre-processed measurement data 6A and normal pre-processed measurement data 6N. The diagnostic arrangement further comprising at least one estimator 15, which each estimator is arranged to follow a specific disturbance condition of the multivariable process utilizing said deviations 6D, 7D, 8D, and to form an estimation 33 of severity of the disturbance condition.

### LIST OF FIGURES

In the following, the invention is described in more detail by reference to the enclosed drawings, where

FIG. 1 illustrates an example of a prior art arrangement,

FIG. 2 illustrates an example of a diagnostic arrangement according to the invention,

FIG. 3 illustrates an example of an estimator according to the invention,

FIG. 4 illustrates another example of an estimator according to the invention,

FIG. 5 illustrates an example of a LE or fuzzy mapping, and.

FIG. 6 illustrates other examples of the LE or fuzzy mapping

### DESCRIPTION OF THE INVENTION

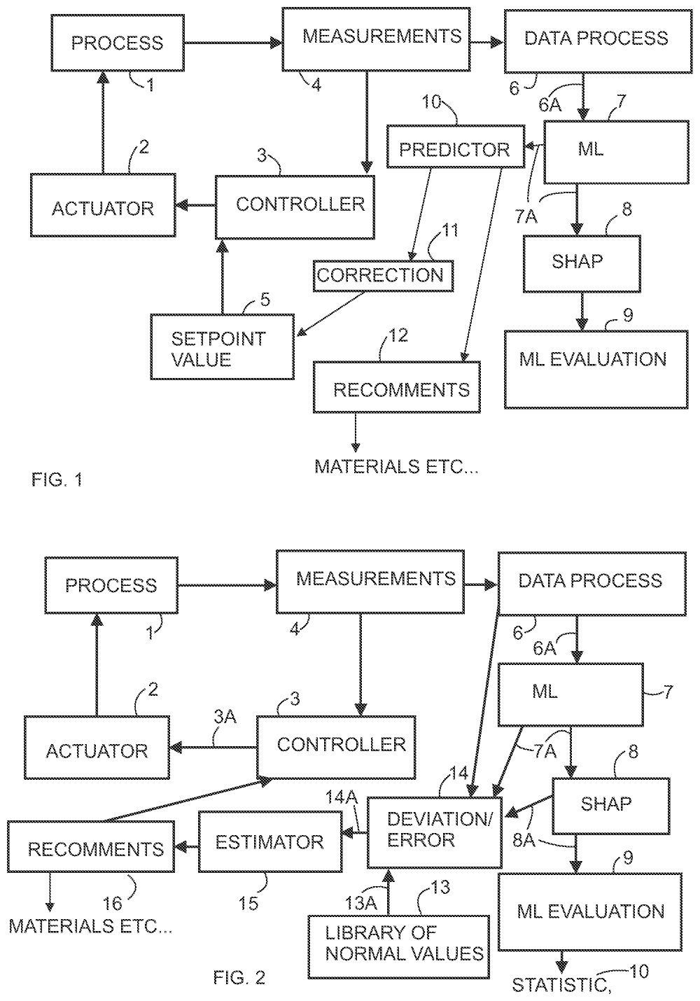

FIG. 2 illustrates an example of an inventive diagnostic arrangement for a multivariable process 1. The process may comprise several processes, so as whole it can be a combination of processes that run together. It comprises a data processing module 6 in order to process measurement data of the multivariable process and to perform pre-processed measurement data 6A. The arrangement further comprises a machine learning module 7 in order to perform machine learning values 7A from the pre-processed measurement data 6A. The diagnostic arrangement comprises also an explanation value module 8 for forming explanation values 8A from the machine learning values 7A, and a deviation calculation module 14. The deviation calculation module is arranged to calculate deviations 8D between the explanation values 8A and normal explanation values 8N, deviations 7D between the machine learning values 7A and normal machine learning values 7N, and deviations 6D between the pre-processed measurement data 6A and normal pre-processed measurement data 6N. The deviation calculation module may have several modules to make said calculation, for example a module for to calculate the deviations 8D between the explanation values 8A and normal explanation values 8N. The deviation calculation module 14 may also be a distributed module having separate modules to make the calculations.

The diagnostic arrangement further comprises at least one estimator 15, which each estimator is arranged to follow a specific disturbance or a specific quality condition of the multivariable process utilizing said deviations 6D, 7D, 8D, and to form an estimation 33 of severity of the disturbance condition. For example, in paper making, one estimator can be arranged to follow retention of fine particles and another estimator to a sizing property. The output 15A of each estimator 15 can be used as such or together with the outputs of the other estimators to provide recommendations and/or guiding commands 16 like commands to change setpoint/s of the controller/s 3, recommendations for changing raw materials of the process/es 1, recommendations to improve water washing, recommendations to optimize retention, quality indexes indicating the health of a process or subprocess etc. The recommendations can vary by a process in question. The output 15A of each estimator can be used as such or together with the outputs of the other estimators for controlling, optimizing or troubleshooting a multivariable process. Controlling and/or optimizing may comprise one of more of controlling dosing amount of chemicals, dosing points of chemicals, dosing intervals of chemicals, selection of chemical types to be used in the process and process conditions, such as pH, temperature, flow rate of process streams.

The explanation values of machine learning and normal explanation values of machine learning are, for example, SHAP values, values from a LIME method, values from a DeepLIFT method or any other possible explanation values.

The LIME method interprets individual model predictions, which are based on locally approximation the model around a given prediction. LIME refers to simplified inputs x as interpretable inputs. The mapping x=hx(x) converts a binary vector of interpretable inputs into the original input space. Different types of hx mappings are used for different input spaces.

DeepLIFT is a recursive prediction explanation method. It attributes to each input xi a value CΔxiΔy that represents the effect of that input being set to a reference value as opposed to its original value. It means that DeepLIFT mapping x=hx(x) converts binary values into the original inputs, where 1 indicates that an input takes its original value, and 0 indicates that it takes the reference value. The reference value represents a typical uninformative background value for the feature.

The SHAP (SHapley Additive exPlanation) explanation values attribute to each feature the change in the expected model prediction when conditioning on that feature. The values explain how to get from a base value an expectation E[f(z)] that is going to be predicted if we did not know any features to the current output f(x). The order how features are added in the expectations matters. However, this is taken into account in SHAP values.

FIG. 2 shows also (like FIG. 1 as well) a process 1 driven by an actuator 2, which actuator is controlled by a controller 3. Measurements 4 are taken from the process and the controller compares the measurements with a setpoint value or values, and forms a control command/s 3A for the actuator 2.

As already described the measurements 4 can also be used for other purposes, and can be pre-processed 6. The pre-processing may, for example, comprise data merging, aligning time format, modifying metadata, data validation etc. In the example of FIG. 2 machine learning 7 is used for extracting information and patterns in large datasets. The recognised patterns can be obtained by building a mathematical model based on a training dataset. Predictions (simulations) and pattern recognition can be made by feeding new data to the mathematical model.

The explanation values 8, like SHAP values, are usually used to track 9 how ML values link back to the input variables. For each prediction a rating number is calculated for each input variable indicating how the variable is contributing to the final predictions. These rating numbers are explanation values indicating the significance of an input value at a given point in time.

As can be noted, the deviation/error between the normal explanation values and the explanation values from the current ML prediction/estimation are calculated, as well as the deviations between the normal ML values and the ML values, and between the normal (pre-processed) measurement data and the pre-processed measurement data. The normal explanation values can be stored library values found from good running periods of the process. So, the normal explanation values 8N of machine learning, normal machine learning values 7N, and normal pre-processed measurement data 6N are values/data 13A that have been derived from good running periods of a process. The normal values can, for example, be derived as simple or median values of these good periods. The normal operation of the process occurs in time-periods where the process or combined processes are running well. So, for all data (pre-processed, ML predictions and ML explanation values) normal (optimal) values can be given (from the stored values) or estimated. Therefore, there can be the library of normal historical values, where the process has been identified to run optimally.

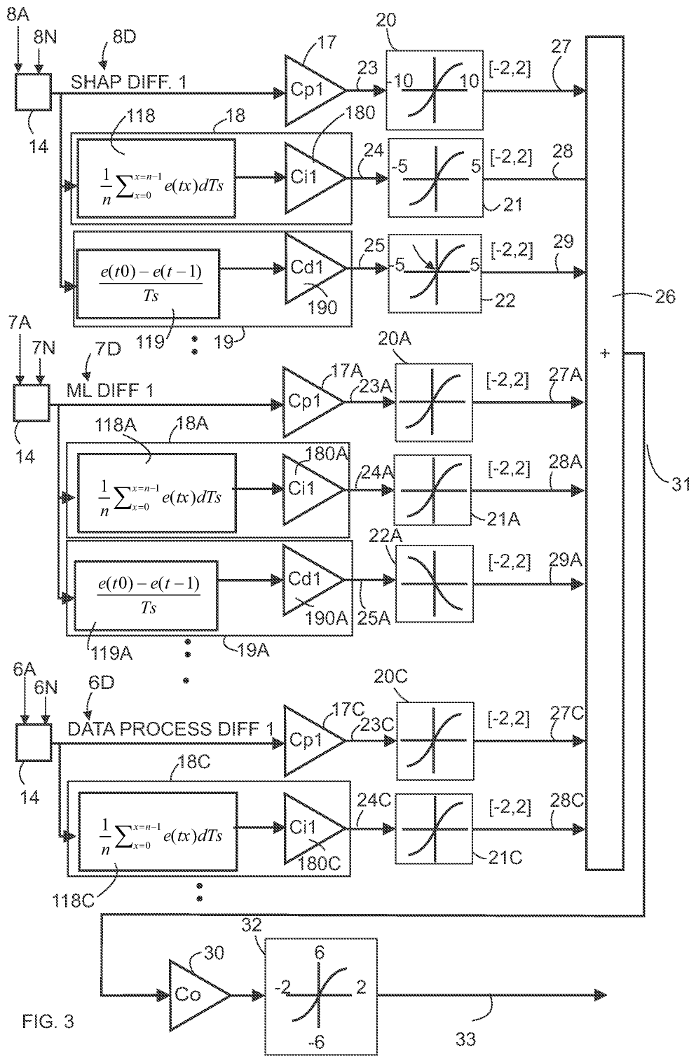

So, differences, deviations or errors are detected from the measurements, the ML values and the explanation values during operation periods where individual or combined processes are not running optimally. This is detected as divergence from the normal values. The differences 6D, 7D, 8D (See FIG. 3) from the normal values 6N, 7N, 8N are used as input to the estimator 15. Although, the deviation calculation module 14 is showed as a separate module, it is also possible that it belongs as a part to the estimator 15. In general, the deviations relate to errors. The greatness of the error indicates the need of changing the setpoint or how much the setpoint should be changed.

FIG. 3 shows an example of the estimator 15, which uses deviations/errors 6D, 7D, 8D. The example of FIG. 3 shows three error values for three variables, but as illustrated more variables and deviation values can be used if needed. So at least one error/deviation value 6D for the measurement data 6A, at least one error/deviation value 7D for the ML value 7A, and at least one error/deviation value 8D for the explanation value 8A are useable in an inventive estimator.

The estimator 15 comprises at least one P module 17, 17A, 17C an I module 18, 18A, 18C or a D module 19, 19A, or any combination of these modules. As said the deviations are input data into the modules. The estimator comprises also input mapping module/s 20, 21, 22, 20A, 21A, 22A, 20C, 21C for each output 23, 24, 25, 23A, 24A, 25A, 23C, 24C of the module. Further, the estimator comprises a summation module 26 to sum output/s 27, 28, 29, 27A, 28A, 29A, 27C, 28C of the input mapping module/s 20, 21, 22, 20A, 21A, 22A, 20C, 21C, and an output scaling module 30 to scale an output 31 of the summation module. Further the estimator comprises an output mapping module 32 in order to provide a normalized output 33. The normalized output is an estimation, which is used for recommendations etc. as said above.

The P, I and D modules 17, 17A, 17C, 18, 18A, 18C, 19, 19A and their combinations PI, PD, ID and PID are known as such, but deviations/errors of explanation values or ML values have not been previously used as inputs. The P-module 17, 17A, 17C has a weighting coefficient, which is multiplied with the input error value. The I-module comprises an integrator unit 118, 118A, 118C which integrates the input error values of a certain period. The integrated input error value is multiplied by the second weighting coefficient 180, 180A, 180C. The D-module comprises a differentiator unit 119, 119A which forms a derivate of the error values during a certain period. The derivate is multiplied by the third weighting coefficient 190, 190A. As can be seen the all P, I, and D modules and their combinations have a weighting coefficient unit. These units may have a same weighting coefficient or different weighting coefficients. The weighting coefficient makes it possible to weight the importance of the proportional (P), integral (I) and differential (D) part of the error value, and also to tune or fine tune the estimation by increasing or decreasing the contribution from each single input calculation.

It is not always needed to have all P, I and D modules, but as said, they can be in the estimator if they are really used. In the embodiment of FIG. 3, the P, I, and D modules together provides a PID calculations for the explanation error values 8D and the ML error values 7D and PI calculations for the errors 6D of the measurement data.

So, an estimator according to the invention comprises at least one module being arranged to handle the deviations 8D between the explanation values 8A and normal explanation values 8N, at least one module being arranged to handle the deviations 7D between the machine learning values 7A and normal machine learning values 7N, and at least one module being arranged to handle the deviations 6D between the pre-processed measurement data 6A and normal pre-processed measurement data 6N. A number of inputs (deviations) used by the estimator may also vary. For example, the estimator may use only one deviation of the measurement data, four deviations for four different ML-values, and two deviations for two different explanation values.

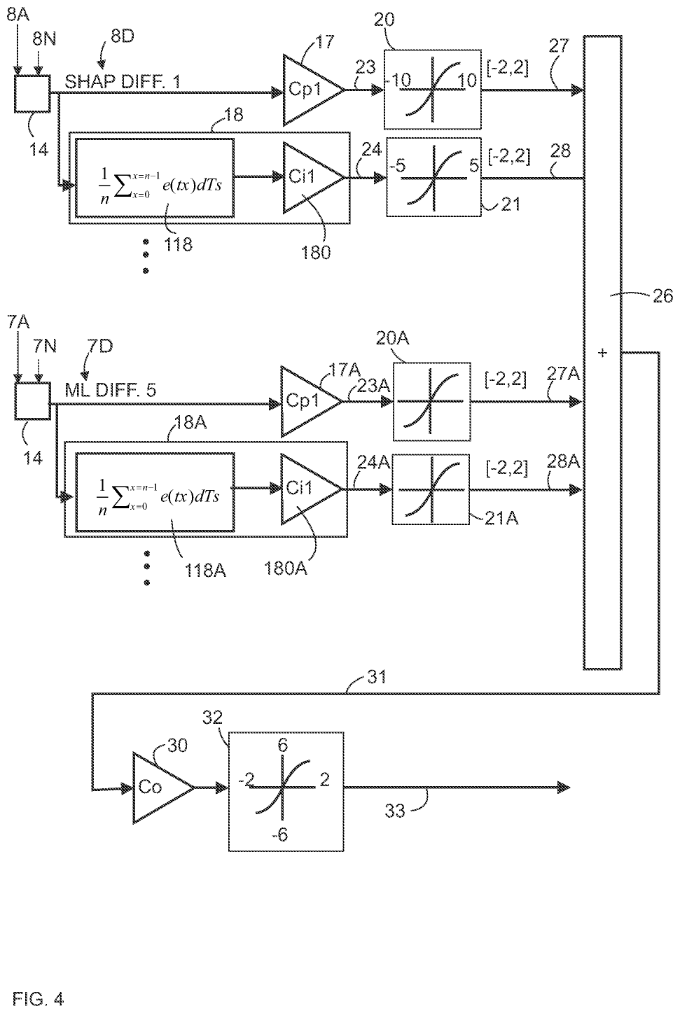

FIG. 4 shows another possible example wherein the D modules are not needed, so the estimator of this example has PI calculations. As said the estimator may have only those modules, which are required for P, I, D, PI, PD, ID or PID calculations of an embodiment of the setpoint controller. It also worth to mention that the estimator may have different calculations for different error values. For example, the embodiment of FIG. 3 may be modified to another solution so that PID calculation is made for the error value 8D, and the P calculation is made for the other error value 7D (i.e. the I module 18A and the D module 19A have been removed).

As described above the setpoint estimator comprises also the input mapping modules 20, 21, 22, 20A, 21A, 22A, 20C, 21C for each output 23, 24, 25, 23A, 24A, 25A, 23C, 24C of the P, I and D modules. See FIG. 3. The input mapping translates the result of each output of the P, I or D module to a value between −2 and 2. This can be seen as normalization of the values. The inputs maps are formed from linguistic equations (LE) or from fuzzy logic. By using the input maps non-linearities can be taken into account conveniently. Tuning of the estimator is also relatively smooth, since the properties of the process are taken into account inside the input-maps. The mapping modules of the estimator may utilize any mapping curve individually. For example, in FIG. 3, the module 20 and 20A may have been formed from LE or one module 20 have been formed form LE and the other 20A from the fuzzy logic.

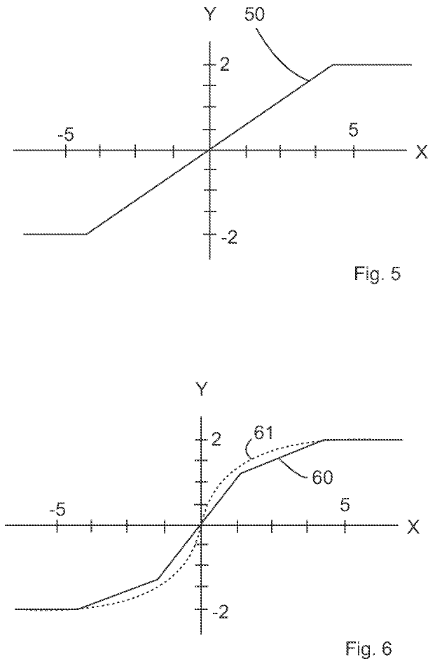

FIG. 5 shows an example of a mapping curve 50, which has formed from the linguistic equations or the fuzzy logic. X is an input variable, which is converted to an output variable Y. Maximum and minimum values are determined for X and Y. A linear formula (like y=ax+b) determines the Y values between X occurs between the maximum and minimum values. If X is greater than the maximum X value, Y is maximum Y. If X is smaller than the minimum X value, Y is minimum Y.

The mapping curve can also be another curve than the linear curve. It can be another curve, which matches better for the features of the process. FIG. 6 shows two other possible examples to the mapping curve. The solid line describes a piecewise linear mapping curve 60, and the dashed line an S-curve mapping 61. Other curves are possible as well. So, refereeing to FIG. 3, the mapping modules may utilize any mapping curve individually. For example, the module 20 and 20A may have the same mapping curve, like a linear curve, or different curves, like different linear curves, or a piecewise linear curve and a S-curve.

The output/s 27, 28, 29, 27A, 28A, 29A, 27C, 28C of the input mapping module/s 20, 21, 22, 20A, 21A, 22A, 20C, 21C, are summed in the summation module 26. So, all deviation/error values are taken into account. The sum output 31 is then scaled by the output scaling module 30, and the scaled sum is normalized by the output mapping module 32 in order to provide a normalized output 33, that is an estimator output.

In addition, the output of one estimator can be used as input to another estimator together with any combinations of measurements, ML predictions and performance values (e.g. SHAP), which provide a cascade connection between the estimators.

An inventive method for forming an estimation of severity of a disturbance condition or a quality condition in a multivariable process utilizes the diagnostic arrangement described in this text for forming an estimation of severity of a disturbance condition or a quality condition. The method uses the estimation of severity of a disturbance condition or a quality condition for providing recommendations and/or guiding commands in the multivariable process for controlling and/or optimizing the multivariable process. The controlling and/or optimizing may comprise one or more of controlling dosing amount of chemicals, dosing points of chemicals, dosing intervals of chemicals, selection of chemical types to be used in the process, process conditions, such as pH, temperature, flow rate of process streams, and process stream delays, such as pulp, broke or water stream delays in process equipment, such as in towers, tanks, pulpers, basins or other process equipment.

The inventive method can control an industrial process being for example a multivariable process, the industrial process being for example a pulp process, papermaking, board making or tissue making process, industrial water or waste water treatment process, raw water treatment process, water re-use process, municipal water or waste water treatment process, sludge treatment process, mining process, oil recovery process or any other industrial process.

As illustrated above the invention provides an automatic way to provide an estimator for analysing the process 1. The process can, for example, be a water treatment process or a paper making process. Process can be an industrial process, for example pulp process, papermaking, board making or tissue making process, industrial water or waste water treatment process, raw water treatment process, water re-use process, municipal water or waste water treatment process, sludge treatment process, mining process, oil recovery process or any other industrial process. The process is usually multivariable process, so a great number of measurements are taken. In order to understand how a ML algorithm has arrived at a predicted value explanation values are formed to evaluate the input parameters. Having also the normal measurement data, the ML values and the explanation values, which indicate that the process runs fine, the deviation/error values of the values/data can be formed, and they can be used for analytic purposes.

The inventive arrangement can be located to the same place as the process that is followed. However, it is also possible that it is located to another place, which makes it possible to remotely follow the process. For example, the measurement data 4 are sent through a communication network/s to the inventive diagnostic, which handles the measurement data and send the estimator/s output/s, which can used for adjusting the process. The estimators outputs can be send to the owner of the process, maintenance centre of the process or any desired destination.

It is evident from the above that the invention is not limited to the embodiments described in this text but can be implemented utilizing many other different embodiments within the scope of the independent claims.

1. A diagnostic arrangement for a multivariable process, the arrangement having a data processing module in order to process measurement data of the multivariable process and to perform pre-processed measurement data, and a machine learning module in order to perform machine learning values from the pre-processed measurement data, wherein the diagnostic arrangement comprises an explanation value module for forming explanation values from the machine learning values, and a deviation calculation module to calculate deviations between the explanation values and normal explanation values, deviations between the machine learning values and normal machine learning values, and deviations between the pre-processed measurement data and normal pre-processed measurement data,
the diagnostic arrangement further comprising at least one estimator, which each estimator is arranged to follow a specific disturbance condition or quality condition of the multivariable process utilizing said deviations, and to form an estimation of severity of the disturbance condition or the quality condition.

2. The diagnostic arrangement according to claim 1, wherein the explanation values of machine learning and normal explanation values of machine learning are SHAP values, values from a LIME method, values from a DeepLIFT method or any other possible explanation values.

3. The diagnostic arrangement according to claim 2, wherein the normal explanation values of machine learning, normal machine learning values, and normal pre-processed measurement data are values/data that have been derived from good running periods of the process.

4. The diagnostic arrangement according to claim 3, wherein estimator comprises at least one P module, an I module, or a D module, or any combination of these modules,
at least one module being arranged to handle the deviations between the explanation values and normal explanation values,
at least one module being arranged to handle the deviations between the machine learning values and normal machine learning values,
at least one module being arranged to handle the deviations between the pre-processed measurement data and normal pre-processed measurement data.

5. A diagnostic arrangement according to claim 4, wherein estimator comprises also input mapping module/s for each output of said module/s, a summation module to sum output/s of the input mapping modules, an output scaling module to scale an output of the summation module, an output mapping module in order to provide a normalized output that is an estimator output.

6. The diagnostic arrangement according to claim 5, wherein said mapping modules have been formed from linguistic equations or fuzzy logic.

7. The diagnostic arrangement according to claim 6, wherein a mapping curves of the mapping modules provide a linear curve, piecewise linear, S-curve and/or another curve form.

8. The diagnostic arrangement according to claim 1 comprising at least one deviation calculation module to provide the deviations between explanation values of machine learning and normal explanation values of machine learning, the deviations between the machine learning values and normal machine learning values, and/or the deviations between the pre-processed measurement data and normal pre-processed measurement data.

9. The diagnostic arrangement according to claim 8, wherein the deviation calculation module is a part of the estimator.

10. The diagnostic arrangement according to claim 8, wherein the deviation calculation module is a separate module from the estimator.

11. The diagnostic arrangement according to claim 1, wherein the estimation of one estimator is an input to the other estimator to be utilized by this other estimator.

12. A method for forming an estimation of severity of a disturbance condition or a quality condition in a multivariable process, wherein a diagnostic arrangement according to claim 1 is used to form an estimation of severity of a disturbance condition or a quality condition.

13. The method according to claim 12, wherein the estimation of severity of a disturbance condition or a quality condition is used to provide recommendations and/or guiding commands in the multivariable process for controlling and/or optimizing the multivariable process.

14. The method according to claim 12, wherein the multivariable process is an industrial process, for example pulp process, papermaking, board making or tissue making process, industrial water or waste water treatment process, raw water treatment process, water re-use process, municipal water or waste water treatment process, sludge treatment process, mining process, oil recovery process or any other industrial process.

15. The method according to claim 13, wherein the controlling and/or optimizing comprises one or more of controlling dosing amount of chemicals, dosing points of chemicals, dosing intervals of chemicals, selection of chemical types to be used in the process, process conditions, such as pH, temperature, flow rate of process streams, and process stream delays, such as pulp, broke or water stream delays in process equipment, such as in towers, tanks, pulpers, basins or other process equipment.
